(19) United States
(12) Patent Application Publication
(10) Pub. No.: US 2004/0244548 A1
(43) Pub. Date: Dec. 9, 2004

(54) CUTTING APPARATUS AND METHOD FOR PRESETTING A CUTTING APPARATUS

(75) Inventors: Michael Zimmermann, Leopoldsdorf (AT); Reinhard Lihl, Vienna (AT); Rainer Wogritsch, Vienna (AT)

Correspondence Address: SIMPSON & SIMPSON, PLLC, 5555 MAIN STREET, WILLIAMSVILLE, NY, 14221-5406, US

(73) Assignee: Leica Mikrosysteme GmbH, Vienna (AT)

(21) Appl. No.: 10/709,871

(22) Filed: Jun. 2, 2004

(30) Foreign Application Priority Data
Jun. 7, 2003 (DE) 103 25 944.9.52

(51) Int. Cl. B26D 1/00; B26D 3/00; G02B 21/06

(52) U.S. Cl. 83/13; 83/915.5

(57) ABSTRACT

In cutting devices (10), in particular microtomes or ultramicrotomes (24), it is necessary to preset the specimen onto the knife (14). To improve the accuracy and reproducibility of this presetting operation, which is intended to ensure the quickest and most accurate possible positioning of the knife (14) relative to the specimen, a pivotable observation device (10), in particular a stereomicroscope, is provided. The observation device (10) is coupled to a pivoting device (28) that comprises a positioning device (29). The positioning device (29) is embodied in such a way that a positioning of the observation device (10) at a defined angle is possible.

### CROSS REFERENCE TO RELATED APPLICATIONS

This application claims priority of the German patent application 103 25 944.9, filed Jun. 7, 2003, which is incorporated by reference herein.

### FIELD OF THE INVENTION

The invention concerns a cutting apparatus for cutting a specimen into a plurality of thin slices. The invention further concerns a microtome or an ultramicrotome for cutting a specimen into a plurality of thin slices. Additionally, the invention concerns a method for presetting a cutting device, in particular a microtome or an ultramicrotome for cutting a specimen into a plurality of thin slices.

### BACKGROUND OF THE INVENTION

When a cutting apparatus, in particular a microtome or an ultramicrotome, is operated, it is routinely necessary for the specimen being cut to be positioned, i.e. aligned, quickly, exactly, and in accurately positioned fashion with respect to the knife. In this so-called presetting operation, care must be taken that neither the knife nor the specimen is damaged. Unintentional contact between the knife and specimen must correspondingly also be prevented.

It has therefore been usual for some time in the context of the presetting operation between knife and specimen, as known e.g. from DE 40 12 600, to assist the approach operation between the specimen and knife using an observation device, in particular a stereomicroscope. With the use of the stereomicroscope, it is also possible to assist the operation of precisely observing and performing the various angular adjustments that are required. The alignment can be observed by a user himself; alternatively, a camera can also be mounted on the stereomicroscope.

In known cutting devices, for example the Reichert Ultracut S of the Leica company, a stereomicroscope having a variably adjustable magnification is used. The stereomicroscope itself is installed with a fixed angle of 20° between the optical axis of the stereomicroscope and its vertical. This has the advantage that an accurate alignment of knife and specimen can be performed for many instances, especially if the relief angle of the knife is 10°. This is because the base-mounted illumination system that is used for alignment has a light exit vertically beneath the knife edge. The light is reflected from the knife edge, at twice the relief angle (i.e. 20°), to the specimen and from there to the stereomicroscope. Under these geometrical conditions, the spacing between the knife and specimen is detectable in the stereomicroscope as a bright gap. The incident-light illumination system that serves for observation of the sections is adapted geometrically in such a way that with this angular arrangement of the stereomicroscope, the water surface acts reflectively.

On the other hand, however, depending on the specimen that is to be cut, it is sometimes also necessary to lower the water level in the knife. The lowered water surface is curved, however, so that the reflectivity of the water surface close to the knife edge is lost. To allow an optimum setting of the stereomicroscope to be made under as many different conditions as possible, a pivotable stereomicroscope has therefore already been used in several units. Ultramicrotomes of the RMC company, for example, in this case e.g. the MTX or MTCL models, possess this pivoting capability. The pivot axis does not, however, coincide with the direction of the knife edge, but instead extends along the underside of the focus drive. This has the disadvantage, however, that pivotable stereomicroscopes of this kind have little practical utility in terms of this alignment capability, since the image shifts with each pivoting motion, necessitating a readjustment. In addition, the final position of the pivoted stereomicroscope, once attained, is often secured only by friction. A displacement capability by way of drives also does not exist, so that each adjustment of the stereomicroscope results in additional alignment effort as a result of image shifting or focus displacement.

In order to configure the pivoting motion in such a way that the observation center, i.e. the knife edge, remains approximately in the center as the stereomicroscope pivots, the stereomicroscope has been embodied, for example in the Reichert Supernova ultramicrotome of the Leica company, in such a way that it is pivotable about the knife blade at an angle of between 12 and 20 degrees. While this does ensure that the stereomicroscope can be adjusted to different water levels in the knife, the capability of setting a defined angle quickly, accurately, and reproducibly is nevertheless absent. Repeated alignment is therefore often necessary, resulting in a considerable loss of time.

### SUMMARY OF THE INVENTION

It is therefore the object of the present invention to propose a cutting device for cutting specimens, in particular a microtome or an ultramicrotome, wherein an optical observation device is adjusted precisely and easily.

According to the present invention, this object is achieved by a cutting apparatus in particular a microtome or an ultramicrotome for cutting a specimen into a plurality of thin slices comprising: an observation device, in particular a stereomicroscope, for observing the cut specimen surface and/or the thin slices, a pivoting device for pivoting the observation device and a positioning device provided with the pivoting device for positioning of the pivoting device at a defined angle.

It is a further object of the present invention to propose a method for presetting a cutting device, in particular a microtome or an ultramicrotome, wherein an optical observation device is adjusted precisely and easily.

The above method is achieved by a method for presetting a cutting device, in particular a microtome or an ultramicrotome for cutting a specimen into a plurality of thin slices, comprising the steps of:

providing an observation device, in particular a stereomicroscope, for observing the cut specimen surface and/or the thin slices;

pivoting the observation device with a pivoting device; and

providing a positioning device wherein the pivoting of the observation device is accomplished to a defined angle.

According to the present invention, in a cutting apparatus for cutting specimens, in particular in a microtome or an ultramicrotome, an observation device, for example a stereomicroscope, is provided for observation of the cut specimen surface and/or the thin slices. A pivoting device is provided for pivoting the observation device. The pivoting device has a positioning device that enables pivoting to a defined angle. The positioning device can be embodied for that purpose, for example, as a detent element, the pivoting motion being possible to defined detent positions. These positions correspond to a defined pivot angle of the observation device. The detent element can also be embodied in such a way that the pivoting device can be positioned, i.e. retained, between the detent points.

If several detent grooves are provided on the pivot element of the pivoting device, it is possible to exploit the advantage that different knife types, such as glass or diamond knives, which require different relief angles, can then also be used.

Positioning is preferably performed using a rotary knob that can likewise have detent elements. Rotation of the rotary knob is thus also effected in detent steps. In addition or as an alternative to the detent device, a position marking can also be provided, having in particular a scale. The observation device can easily be set in defined angular positions using this scale, and the microscope can thereby be reproducibly aligned.

Memory media can be provided to store specific angular positions of the observation device. These can be embodied, for example, electronically. It is also possible, however, to configure the memory media mechanically; this can be done, for example, by configuring a detent element displaceably. It is thus easy to return accurately to that detent position.

### BRIEF DESCRIPTION OF THE DRAWINGS

Further advantages and advantageous embodiments of the invention are the subject matter of the Figures below and their descriptions.

In the individual Figures:

FIG. 1 shows a stereomicroscope according to the existing art mounted at a fixed angle;

FIG. 2 is a side view of a cutting device according to the present invention;

FIG. 3 shows a portion of a cutting device according to the present invention, with a section through the pivoting device;

FIG. 4 is a side view of a portion of a cutting device according to the present invention; and

FIG. 5 depicts a detail of a detent element.

### DETAILED DESCRIPTION OF THE INVENTION

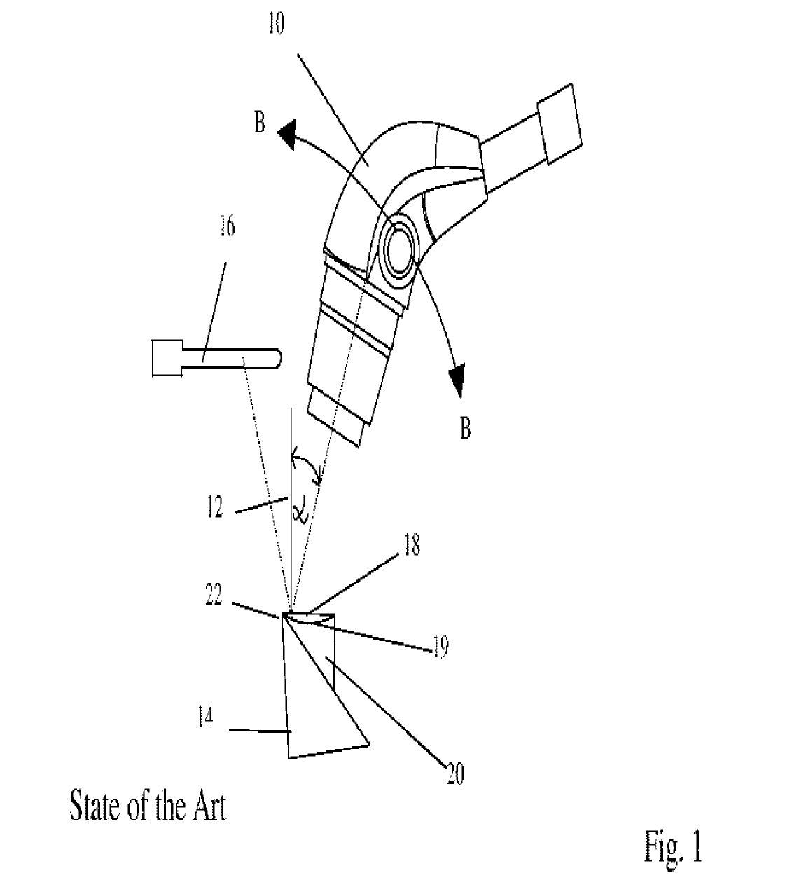

To illustrate the problem underlying what is sought to be patented, FIG. 1 schematically depicts a stereomicroscope 10 according to the existing art. This stereomicroscope 10 is mounted at a fixed angle α (with respect to vertical 12. This configuration results in optimum contrast for alignment of knife 14 when a relief angle of 10 degrees is maintained for knife 14. This arrangement has the advantage that the knife and specimen can be adjusted very accurately. Incident-light illumination system 16 is geometrically adapted in such a way that with a flat water level, i.e. a flat water surface 18, the surface of the water reflects. For applications that require a lowered water surface 19 in knife pan 20, this fixed geometric coordination is unfavorable, since a lowered water surface 19 is curved. The reflection of the water surface close to knife blade 22 is lost, so that the cutting and alignment operations can no longer be observed adequately with relief angles not equal to 10°.

To compensate for this disadvantage, microscopes are already known that are pivotable along arc B so that angle α can be variably adjusted. This adjustment capability results in a geometric adaptation to the particular water levels required in knife pan 20. It must be ensured in this context, however, that the pivoting motion occurs about an axis whose direction is defined by knife edge 22. A pivotable stereomicroscope can thus be displaced in accordance with the curved water surface in such a way that a reflection of light source 16 is once again achieved.

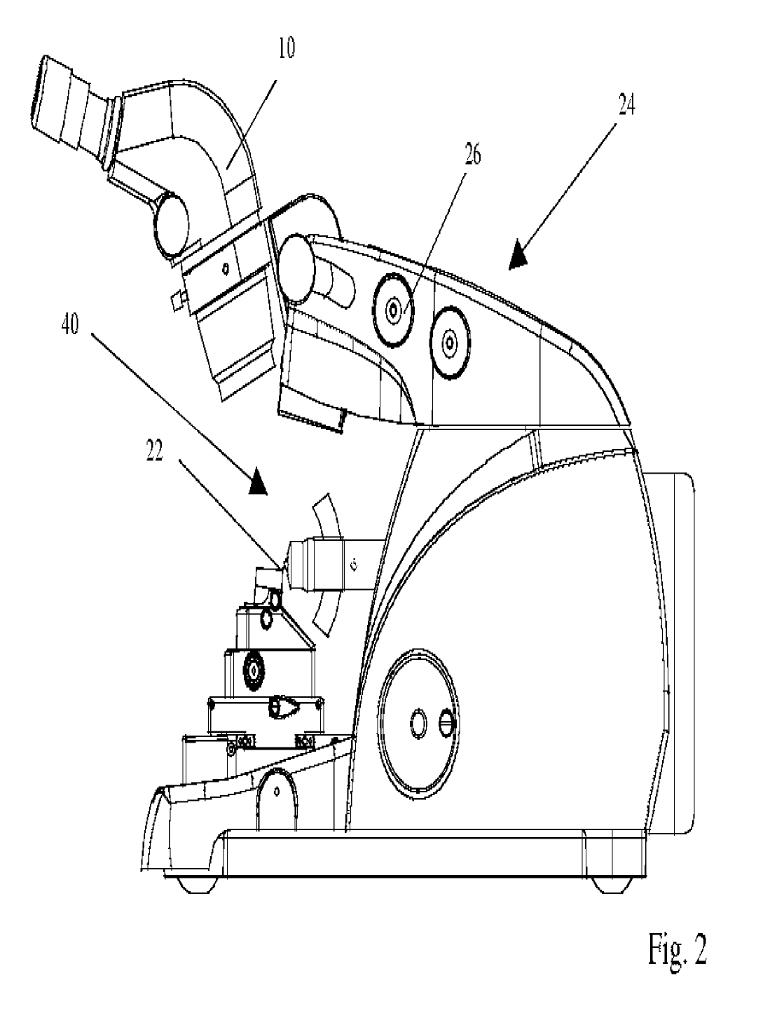

FIG. 2 now shows, in a side view, an ultramicrotome 24 according to the present invention having a pivotable stereomicroscope 10. The pivoting motion can be implemented using a rotary knob 26, the pivoting motion of stereomicroscope 10 proceeding about an axis whose direction is defined by knife edge 22.

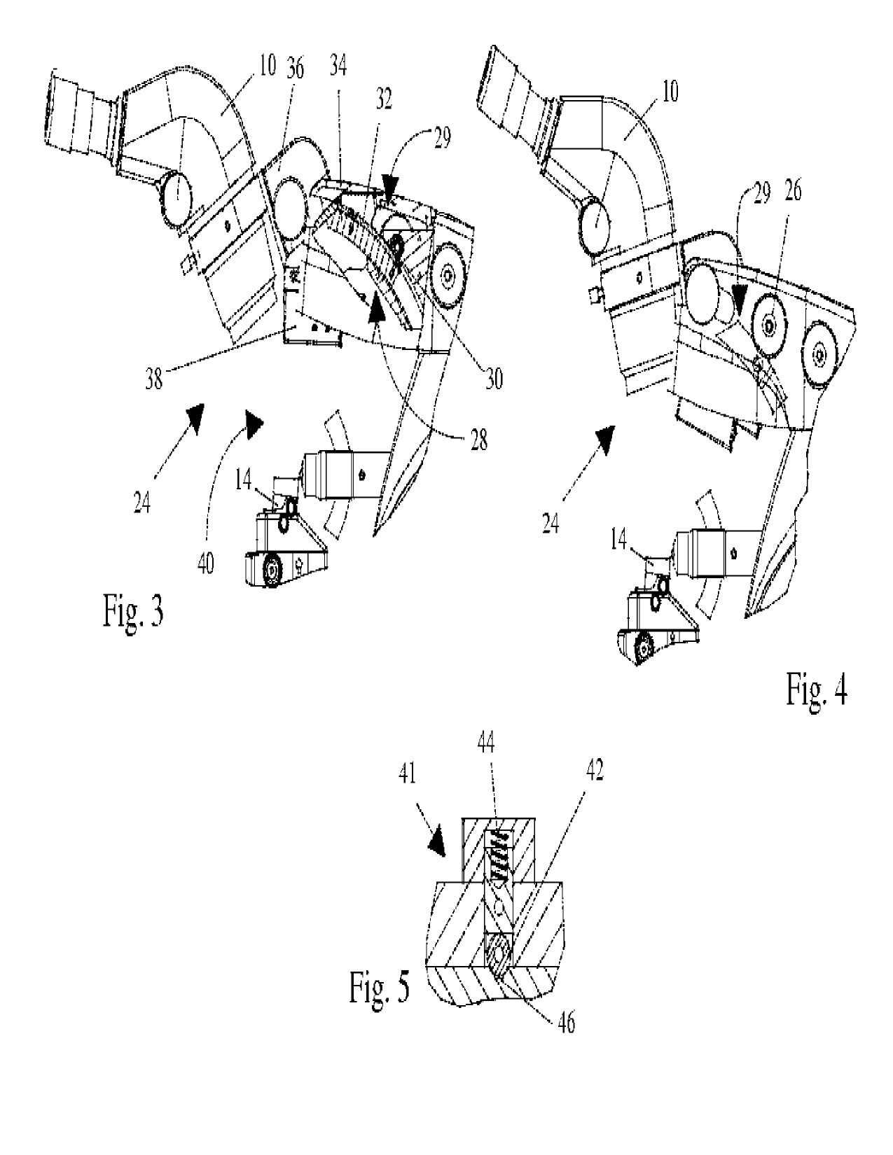

FIG. 3 depicts a portion of ultramicrotome 24 in an enlarged partial depiction. In the present case, pivoting device 28 has a pinion 30. A rotation of pinion 30, which runs in a toothed rack 32, causes a motion of toothed rack 32, which is curved. As a result, segment 34 is displaced within its guide. A focus drive 36 is provided on segment 34. Stereomicroscope 10 and an illumination device 38 for illuminating working area 40, in which knife 14 is also located, are provided in turn on focus drive 36.

As depicted in FIG. 4, pinion 30 can be driven via knob 26. FIGS. 3 and 4 each show different pivot angles of stereomicroscope 10, brought about by rotation of knob 26. Positioning, i.e. assumption of an exact pivot angle, is accomplished correspondingly by way of a detent-stopped further motion of segment 34. The defined further motion is guaranteed by way of the coupling of pinion 30 to toothed rack 32.

One possible embodiment of a detent element 41 is shown in FIG. 5. Here a ball 42 is pushed by means of a spring 44 into a groove 46. As soon as ball 42 engages into groove 46, a defined detent position has been assumed. The detent element can be arranged on the rigid guide, and the groove conversely on the movable segment. Upon actuation of knob 26, engagement is clearly perceptible by the user. Advantageously, however, in addition to all the detent positions, all other desired non-detent-stopped positions of the pivoting motion can also be established and retained.

Several detent grooves can, of course, also be provided on the pivot element. This means that an optimally suitable detent can be selected, for example, for different types of knife, e.g. glass or diamond knives, that each require different relief angles. With the provision of different detent grooves it is correspondingly possible to adjust the observation angle optimally during alignment, again as a function of the knife being used. In addition, it is thus also possible to implement different detent spacings and thus bring about different, mechanically settable accuracy levels.

The detent element described here is to be regarded only as an example, since there are many possibilities for implementing detent elements. For example, a detent element can be mounted directly on the shaft of rotary knob 26.

In addition, apparatuses can be provided that make possible storage of the individual values for different users. This can be effected, for example, mechanically, the detent element being configured displaceably.

Instead of or in addition to a detent element, a scale can also be mounted on rotary knob 26. The provision of this scale allows a specific angular position to be arrived at and recorded reproducibly. For applications in which the user has the ability also to keep the scale in view, it is thereby possible to create a very simple and effective device that allows the stereomicroscope angle to be set accurately and reproducibly.

1. A cutting apparatus, in particular a microtome or an ultramicrotome for cutting a specimen into a plurality of thin slices comprising: an observation device, in particular a stereomicroscope, for observing the cut specimen surface and/or the thin slices, a pivoting device for pivoting the observation device and a positioning device provided with the pivoting device for positioning of the pivoting device at a defined angle.

2. The cutting apparatus as defined in claim 1, wherein the positioning device comprises a detent element that makes possible positioning of the pivoting device in defined detent positions that correspond to a plurality of defined angles (α).

3. The cutting apparatus as defined in claim 2, wherein the detent element is embodied in such a way that a positioning of the pivoting device between the detent positions is also possible.

4. The cutting apparatus as defined in claim 2, wherein one or more detent grooves are provided on a pivot element of the pivoting device.

5. The cutting apparatus as defined in claim 2, wherein a rotary knob that comprises the detent element is provided for positioning the pivoting device.

6. The cutting apparatus as defined in claim 1, wherein the positioning device comprises a position marking, in particular a scale.

7. The cutting apparatus as defined in claim 1, wherein a position storage device is provided for storing an angular position of the observation device.

8. A microtome or an ultramicrotome for cutting a specimen into a plurality of thin slices comprising: a stereomicroscope, for observing the cut specimen surface and/or the thin slices, a pivoting device for pivoting the stereomicroscope, a positioning device provided with the pivoting device for positioning of the pivoting device at a defined angle and a detent element that makes possible positioning of the pivoting device in defined detent positions that correspond to a plurality of defined angles (α).

9. A method for presetting a cutting device, in particular a microtome or an ultramicrotome for cutting a specimen into a plurality of thin slices, comprising the steps of:
providing an observation device, in particular a stereomicroscope, for observing the cut specimen surface and/or the thin slices;
pivoting the observation device with a pivoting device; and
providing a positioning device wherein the pivoting of the observation device is accomplished to a defined angle.

10. The method as defined in claim 9, wherein the pivoting is accomplished to defined detent positions that are provided on the positioning device.

11. The method as defined in claim 9, wherein the pivoting is accomplished to a defined position marking, and the position marking being provided on the positioning device.

12. A method for presetting a microtome or an ultramicrotome for cutting a specimen into a plurality of thin slices, comprising the steps of:
providing a stereomicroscope, for observing the cut specimen surface and/or the thin slices;
pivoting the stereomicroscope with a pivoting device; and
providing a positioning device wherein the pivoting of the stereomicroscope is accomplished to a defined angle.
